(19) United States
(12) Patent Application Publication
(10) Pub. No.: US 2021/0354968 A1
(43) Pub. Date: Nov. 18, 2021

(54) LOAD DETECTION FOR AN AERIAL LIFT ASSEMBLY

(71) Applicant: Terex South Dakota, Inc., Watertown, SD (US)

(72) Inventors: Ben Vander GRIEND, Bellingham, WA (US); Branden CATTANACH, Seattle, WA (US); Grant DUFFY, Seattle, WA (US)

(21) Appl. No.: 17/318,059

(22) Filed: May 12, 2021

Related U.S. Application Data
(60) Provisional application No. 63/024,613, filed on May 14, 2020.

(51) Int. Cl. B66F 17/00; B66F 11/04

(52) U.S. Cl. CPC B66F 17/006; B66F 11/042

(57) ABSTRACT

An aerial lift assembly is provided with a chassis. A linkage assembly is provided with a plurality of pivotally connected links. The linkage assembly is mounted to the chassis to extend and retract from the chassis. A platform is supported upon the linkage assembly to extend and retract from the chassis. A load sensor is provided upon a pivotal connection of one of the plurality of links of the linkage assembly.

### CROSS-REFERENCE TO RELATED APPLICATIONS

This application claims the benefit of U.S. provisional application Ser. No. 63/024,613 filed May 14, 2020, the disclosure of which is hereby incorporated in its entirety by reference herein.

### TECHNICAL FIELD

Various embodiments relate to aerial lift assemblies.

### BACKGROUND

The prior art has provided load sensing systems for aerial lift assemblies. One prior art load sensing system utilizes hydraulic pressure sensors to measure hydraulic pressure in the lift cylinders. The prior art has also provided load sensing pins at the platform to directly measure platform load.

### SUMMARY

According to an embodiment, an aerial lift assembly is provided with a chassis. A linkage assembly is provided with a plurality of pivotally connected links. The linkage assembly is mounted to the chassis to extend and retract from the chassis. A platform is supported upon the linkage assembly to extend and retract from the chassis. A load sensor is provided upon a pivotal connection of one of the plurality of links of the linkage assembly.

According to a further embodiment, the load sensor is further defined as only one load sensor.

According to another further embodiment, an actuator is connected to the linkage assembly to extend and retract the linkage assembly.

According to an even further embodiment, the load sensor is provided upon the connection of the actuator and the linkage assembly.

According to another even further embodiment, a pin is the pivotal connection of the actuator and the linkage assembly.

According to another further embodiment, the load sensor is provided to detect an applicable load and load vector.

According to another further embodiment, a controller is in communication with the load sensor to receive an applicable load measurement and a load vector for each of a plurality of positions.

According to an even further embodiment, the controller is programmed to calculate a platform height in response to receipt of the applicable load measurements and the load vectors for the plurality of positions.

According to another further embodiment, the controller is programmed to calculate a platform load in response to receipt of the applicable load measurements and the load vectors for the plurality of positions.

According to another further embodiment, the linkage assembly is further provided with a series of pivotally connected stack links that are retractable to collapse and stack upon the chassis.

According to an even further embodiment, an actuator is connected to the linkage assembly to extend and retract the linkage assembly.

According to an even further embodiment, the load sensor is provided upon the connection of the actuator and the linkage assembly.

According to another embodiment, an aerial lift assembly is provided with a chassis. A linkage assembly is connected to the chassis to extend and retract from the chassis. A platform is supported upon the linkage assembly to extend and retract from the chassis. An actuator is connected to the linkage assembly to extend and retract the linkage assembly. A load sensor is provided upon the connection of the actuator and the linkage assembly.

According to a further embodiment, the pivotal connection of the actuator and the linkage assembly is a pin.

According to an even further embodiment, the load sensor detects an applicable load and load vector.

According to an even further embodiment, the aerial lift assembly is further provided with a controller in communication with the load sensor. The controller receives an applicable load measurement and a load vector for each of a plurality of positions.

According to an even further embodiment, the controller calculates a platform height in response to receipt of the applicable load measurements and the load vectors for the plurality of positions.

According to an even further embodiment, the controller calculates a platform load in response to receipt of the applicable load measurements and the load vectors for the plurality of positions.

According to another embodiment, an aerial lift assembly is provided with a chassis. A linkage assembly is provided with a plurality of pivotally connected links. The linkage assembly is connected to the chassis to extend and retract from the chassis. A platform is supported upon the linkage assembly to extend and retract from the chassis. An actuator is connected to the linkage assembly to extend and retract the linkage assembly. A pin is the pivotal connection of the actuator and the linkage assembly. A load sensor is provided upon the pin of the actuator and one of the plurality of links of the linkage assembly to detect an applicable load and load vector. A controller is in communication with the load sensor to receive an applicable load measurement and a load vector for each of a plurality of positions. The controller is programmed to calculate a platform height in response to receipt of the applicable load measurements and the load vectors for the plurality of positions. A platform load is calculated in response to receipt of the applicable load measurements and the load vectors for the plurality of positions.

According to a further embodiment, the linkage assembly is further provided with a series of pivotally connected stack links that are retractable to collapse and stack upon the chassis.

### BRIEF DESCRIPTION OF THE DRAWINGS

FIG. 1 is a perspective of an aerial lift assembly according to an embodiment, illustrated in a partially extended position;

FIG. 2 is a partial perspective view of the aerial lift assembly of FIG. 1 illustrated in a partially extended position in a work environment;

FIG. 3 is a perspective view of an aerial lift assembly according to another embodiment, illustrated in a partially extended position;

FIG. 4 is a perspective view of a linkage assembly of the aerial lift assembly of FIG. 3 illustrated in an extended position;

FIG. 5 is an enlarged perspective view of a region of the linkage assembly of FIG. 4;

FIG. 6 is an enlarged side elevation view of the region of the linkage assembly of FIG. 5;

FIG. 7 is a section view of a pivotal connection of the linkage assembly of FIG. 6 according to an embodiment;

FIG. 8 is a side elevation view of a pivot pin of the pivotal connection of FIG. 7 according to an embodiment;

FIG. 9 is a perspective view of an aerial lift assembly according to an embodiment, illustrated partially extended; and

FIG. 10 is a partial section view of a cylinder rod assembly of an aerial lift assembly according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aerial lift assemblies provide an operator platform on a linkage assembly that pivots and/or translates to lift the operator platform to an elevated worksite. Conventional aerial lift assemblies include various adjustable structures to lift an operator platform to a height for performing a work operation. The aerial lift assemblies often include a stack linkage assembly. The aerial lift assemblies often include an articulated boom assembly, which may be provided by a four-bar linkage mechanism or an extending riser type linkage.

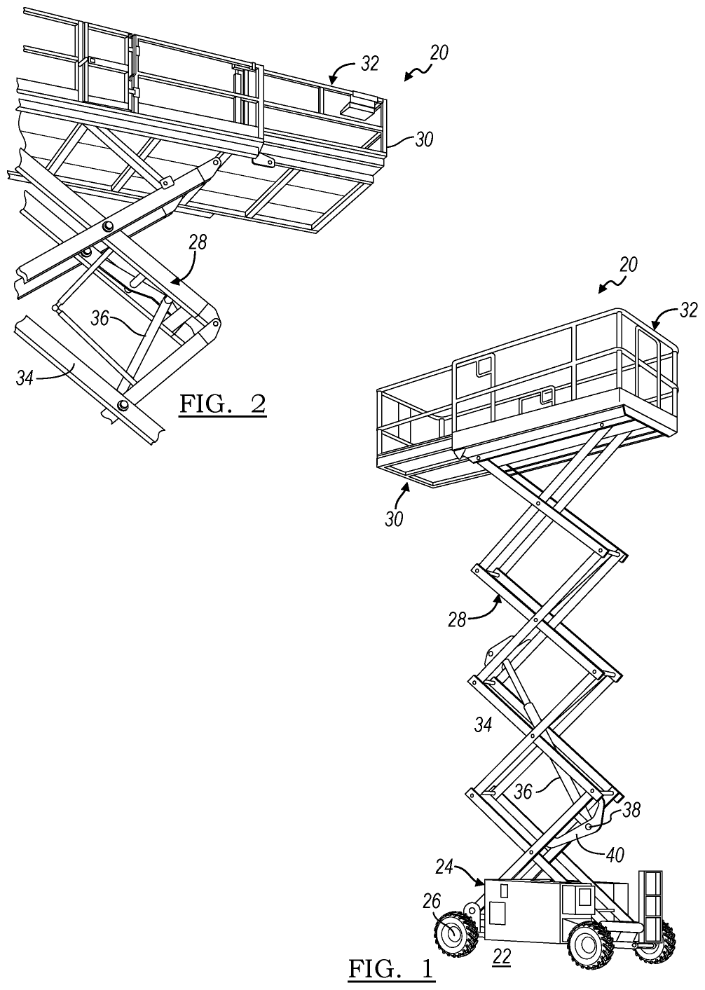

FIGS. 1 and 2 illustrate an aerial lift assembly 20 according to an embodiment. The aerial lift assembly 20 is a mobile aerial lift assembly 20, which is collapsible for transportation upon an underlying support surface 22, such as the ground or a floor (FIG. 1). The aerial lift assembly 20 is also transportable for towing and transport upon a trailer behind a truck. The aerial lift assembly 20 is expandable by operator control to lift an operator to an elevated worksite. The aerial lift assembly 20 is discussed with relation to the ground 22. Therefore, terms such as upper, lower, and other height related terms are relative to height from the ground 22 are not to limit the aerial lift assembly 20 to ground 22 specific applications.

The aerial lift assembly 20 includes a lift structure that provides significant stability and performance characteristics by elevating a worker to an advantageous position for reach while providing stability. The aerial lift assembly 20 includes a chassis 24 (FIG. 1) to support the aerial lift assembly 20 upon the ground 22 or any support surface. The chassis 24 is supported upon a plurality of wheels 26 that contact the ground 22. A linkage assembly 28 is connected to the chassis 24 to extend and retract from the chassis 24. A platform 30 is provided on the linkage assembly 28 to extend and retract from the chassis 24. The platform 30 includes perimeter railing 32 extending upward from the platform 30 to enclose an operator workspace upon the platform 30.

The aerial lift assembly 20 is utilized to lift the platform 30 and workers to elevated work locations to perform work operations. The linkage assembly 28 is a stack linkage assembly 28, with a series of pivotally connected stack links 34 that retract to collapse and stack upon the chassis 24 for compactness for storage and transportation. The lowermost stack links 34 are pivotally connected to the chassis 24 at the proximal ends. At least one pair of the lowermost stack links 34 is also connected at the proximal ends to translate horizontally relative to the chassis 24. Each layer of stack links 34 include converging pairs that are pivotally connected intermediately. Distal ends of each stack link 34 are pivotally connected to a proximal end of one of the next sequential layer of stack links 34, except for the uppermost layer of stack links 34. The stack links 34 of the uppermost layer are each pivotally connect at the distal ends to the platform 30. At least one pair of the uppermost layer of stack links 34 is also connected to the platform 30 to translate relative to the platform 30.

The aerial lift assembly 20 also includes an actuator assembly 36 to extend and retract the linkage assembly 28 and consequently, extend and retract the platform 30. In the depicted embodiment, the actuator assembly 36 includes a plurality of linear actuators pivotally connected to some of the stack links 34. Actuation of the actuator assembly 36 extends the linear actuators to extend the linkage assembly 28. Likewise, actuation of the actuator assembly 36 to retract the linear actuators retracts the linkage assembly 28. The actuator assembly 36 may include hydraulic cylinders, electric servo motors, or any suitable actuator.

Loading of the aerial lift assembly 20 is measured to determine an applicable load upon the aerial lift assembly 20. The loading can be utilized for operational and/or safety purposes. The prior art has provided load sensing systems for aerial lift assemblies. One prior art load sensing system utilizes hydraulic pressure sensors to measure hydraulic pressure in the lift cylinders, which can be used to approximate the platform load given a link stack height. Hydraulic pressure is partially dependent on oil temperature and can lead to inaccurate platform load approximations if the oil temperature changes. Additionally, frictional effects can affect the hydraulic oil pressure leading to further inaccuracies. The prior art has also provided load sensing pins at the platform to directly measure platform load. Load sensing pins at the platform typically measures the load at three or four locations. Multiple load sensing pins increase cost and complexity of an aerial lift assembly.

The aerial lift assembly 20 includes a single load sensing pin 38 at a pivotal connection of the actuator assembly 36 to an intermediate link 40 that is pivotally connected to a pair of stack links 34 in the linkage assembly 28.

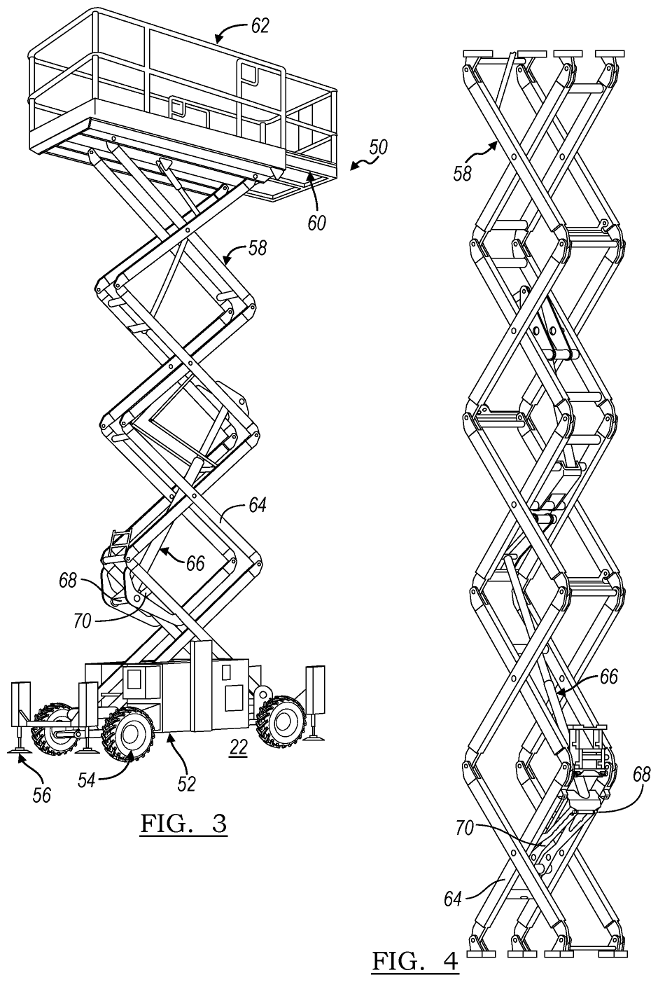

FIG. 3 illustrates an aerial lift assembly 50 according to another embodiment. The aerial lift assembly 50 includes a chassis 52 to support the aerial lift assembly 50 upon the ground 22. The chassis 52 is supported upon a plurality of wheels 54 that contact the ground 22 for support and mobility of the aerial lift assembly 50. The chassis 52 also includes a plurality of supports 56 to extend down and contact the ground 22 to stabilize the chassis 52 during a work operation.

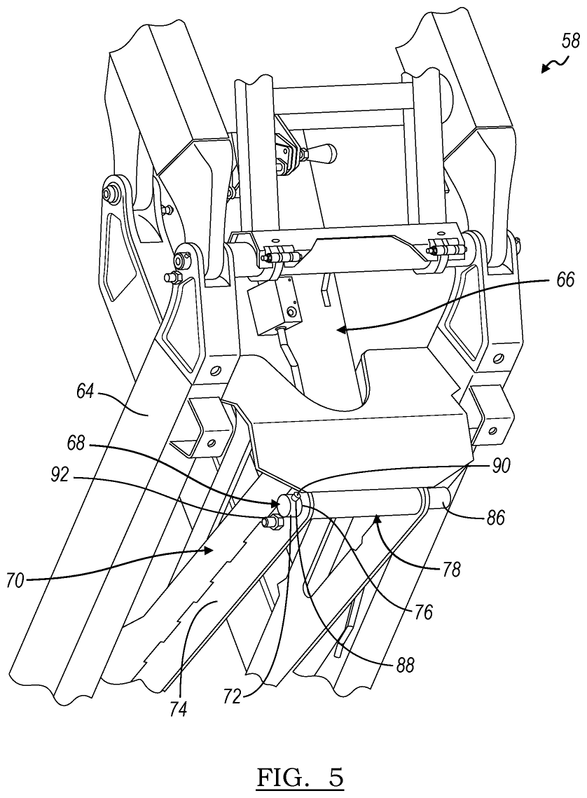

A linkage assembly 58 is connected to the chassis 52 to extend and retract from the chassis 52. The linkage assembly 58 is also illustrated in FIG. 4, in a further extended position. Referring again to FIG. 3, a platform 60 is provided on the linkage assembly 58 with a perimeter railing 62. Referring now to FIGS. 3 and 4, the linkage assembly 58 is a stack linkage assembly 58, with a series of pivotally connected stack links 64 that retract to collapse and stack upon the chassis 52 for compactness for storage and transportation.

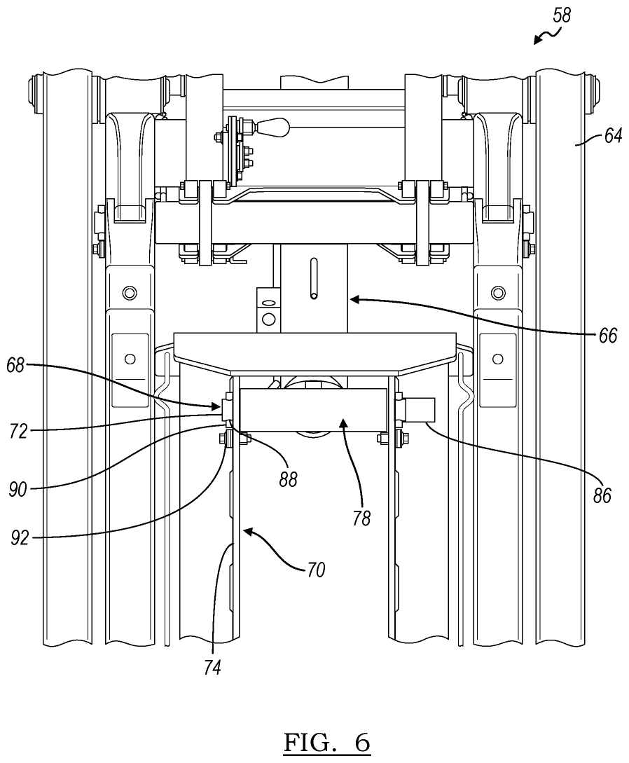

The aerial lift assembly 50 also includes an actuator assembly 66. Referring now to FIGS. 3-7, a single load sensing pin 68 pivotally connects the actuator assembly 36 to an intermediate link 70 that is pivotally connected to a pair of stack links 64 in the linkage assembly 58. The load sensing pin 68 is illustrated removed from the linkage assembly 58 in FIG. 8. Referring to FIGS. 5-8, the pin 68 includes a cylindrical body 72 with a consistent diameter along the length of the body 72. The cylindrical body 72 receives shear loads applied across the body 72.

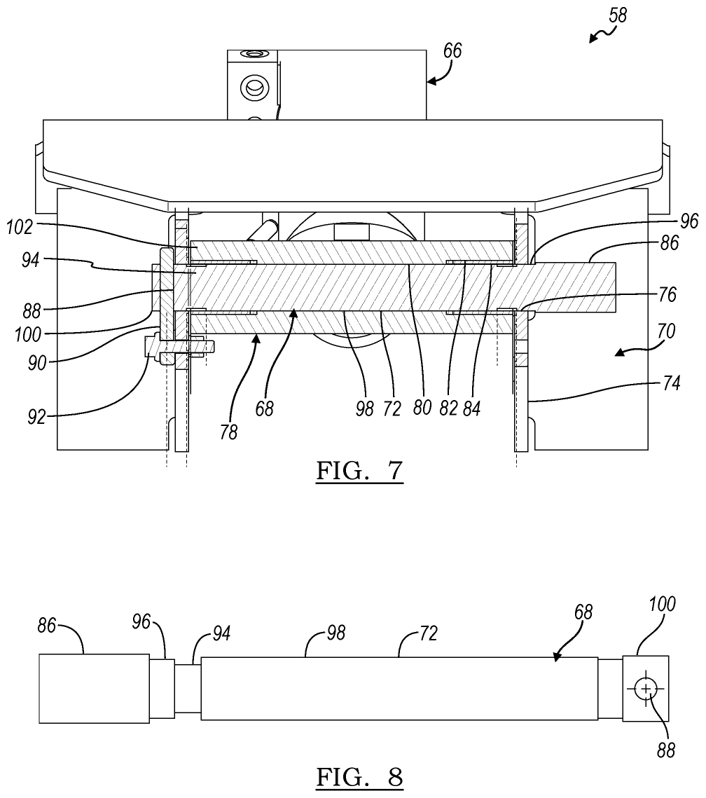

In FIGS. 5-7, the intermediate links 70 each include an inboard sidewall 74. An aperture 76 (FIGS. 5 and 7) is formed in each sidewall 74 that is sized to receive and support the body 72 of the pin 68. Referring again to FIGS. 5-7, the actuator assembly 66 includes a clevis mount 78 pivotally supported upon the pin 68. As illustrated in FIG. 7, a through bore 80 is formed laterally through the clevis mount 78. The through bore 80 is oversized relative to the pin body 72 so that the clevis mount 78 can pivot relative to the pin 68. A pair of counterbores 82 are formed in lateral ends of clevis mount 78, which are oversized relative to the through bore 80. A pair of bushings 84 are installed into the counterbores 82 of the clevis mount 78. The bushings 84 are sized to engage the pin body 72 to support the clevis mount 78 upon the pin body 72, while providing a reduced friction between the pin body 72 and the clevis mount 78 for pivoting of the clevis mount 78 relative to the pin body 72.

With reference again to FIGS. 5-8, the pin 68 includes a head 86. The head 86 has a diameter greater than the aperture 76 in the intermediate link sidewall 74 to avoid over-insertion of the pin 68 into the aperture 76. The head 86 also has a length sufficient to be grasped manually for installation and assembly. The pin body 72 has a length sufficient to pass through the sidewalls 74 of the intermediate links 70 and through the clevis mount 78. A transverse aperture 88 is formed through the distal end of the pin body 72, exposed beyond the intermediate link sidewall 74. A cross-pin 90 is installed into the transverse aperture 88. The cross-pin 90 retains the pin 68 installed into the intermediate links 70 and the clevis mount 78. The cross-pin 90 also prevents the pin 68 from rotating relative to the intermediate links 70 to control the pivotal connection such that the clevis mount 78 pivots relative to the pin 68. The cross-pin 90 is fastened to the adjacent sidewall 74 by a bolt 92.

Referring now to FIGS. 7 and 8, a pair of recesses or bridges 94 are formed into the pin 68. The bridges 94 have a reduced diameter relative to the pin body 72. The bridges 94 separate the pin body 72 into three portions including a proximal end 96, a central region 98, and a distal end 100. The proximal end 96 is oriented adjacent the head 86 and received in one of the intermediate link sidewalls 74. The central region 98 is received within the bushings 84 in the clevis mount 78 of the actuator assembly 66. The distal end 100 is received in, and extends through, the other intermediate link sidewall 74.

With reference to FIG. 7, a load sensor 102 is installed within each bridge 94 in the pin 68. The load sensor 102 may be a strain gauge to detect a strain upon the pin 68, which may be utilized to determine an applicable load, and load direction or load vector. Although one load sensing pin 68 is depicted, and described, multiple load sensing pins 68 may be employed. Although two load sensors 102 are illustrated, one load sensor 102 may be employed. However, multiple load sensors 102 provide redundancy for confirmation of measurements, and for extending a life cycle of the load sensing pin 68.

The load sensors 102 sense deflection of the pin 68 and measure a resulting force at a fixed force vector. Electronic circuits conduct digital information using network protocol to a controller in the chassis 52 that calculates the magnitude of the force from the actuator assembly 66 and the angle that the force is applied. Based on the angle of the applied load, and the location of supporting stack links 64, a height of the platform 60 is calculated. A velocity and a travel direction of the platform 60 are also calculated based on a change of the force vector or vectors. Using a control logic system, a weight applied to the platform 60 is calculated. Limits can be placed in the control logic to support overload control and height related performance/envelope control. Information from this system can also be reported through telematics to allow operation of the aerial lift assembly 50 in different modes depending on end-user requirements. For rental applications, loading conditions can be stored for end user reports on rental operations. Remote diagnostic capability can also be evaluated to minimize repair time and reduce the number of part failures.

Empirical testing demonstrates that the proposed aerial lift assembly 20 is more accurate and repeatable with less hysteresis and less temperature interference that hydraulic pressure detection. The aerial lift assembly 50 is designed with one load sensing pin 68 to reduce a quantity of design components, such as an omission of limits switches, pressure sensors, angle sensors, wiring harnesses, and the like. The aerial lift assembly 50 with the load sensing pin 68 increases manufacturability due to reduced part count and avoids operators and technicians from climbing into the linkage assembly 28 to adjust sensor locations. The aerial lift assembly 50 improves accuracy by reducing the quantity of items than may potentially fail and eliminates analog signals for transmitting data by replacing with digital communication. The aerial lift assembly 50 with the load sensing pin 68 improves reliability over prior art hydraulic pressure detection systems because the load sensing pin 68 is not actuated and operates in a sealed environment. Isolation of the load sensing to a single component, pin 68, reduces the time and cost for repair and replacement. Traditional hydraulic load sense systems are susceptible to varying load sense values due to temperature changes in the oil. The hydraulic load sense systems are impacted by flow rate related to head loss due to pressures modified due to orifices between the piston and counterbalance valves. Measurement signal error due to hysteresis in a hydraulic cylinder is also eliminated.

Various iterations are contemplated for various applications in different aerial lift assemblies. A single load sensing direction, or multiple load sensing directions can be implemented into the load sensing pin 68. The load sensing pin 68 can be installed at any pivotal location of the actuator assembly 66, for example at a lower pivotal connection, or an upper pivotal connection. Although the load sensing pin 68 is affixed against rotation relative to the intermediate link 70, the load sensing pin could be fixed with the clevis mount 78 of the actuator assembly 66. The length and diameter of the load sensing pin 68 can vary for various implementations. The sensor measurement and reporting can be in analog or multiple digital formats. Other pin retention retainers may include banjo bolts, threaded fasteners, or the like. Controller logic for reporting the signal information can be located in the pin or a remote controller. The sensor output can be directly interpreted by an onboard integrated controller or by an external controller that provides input to existing control system so it can be added on to an existing system. The load sensing pin 68 can be installed in any pin locations in a linkage assembly 58 to obtain platform 60 load center-of-gravity location information. A single load cell 102 can be placed in line with a cylinder of the actuator assembly 66 to be used in combination with an angle sensor.

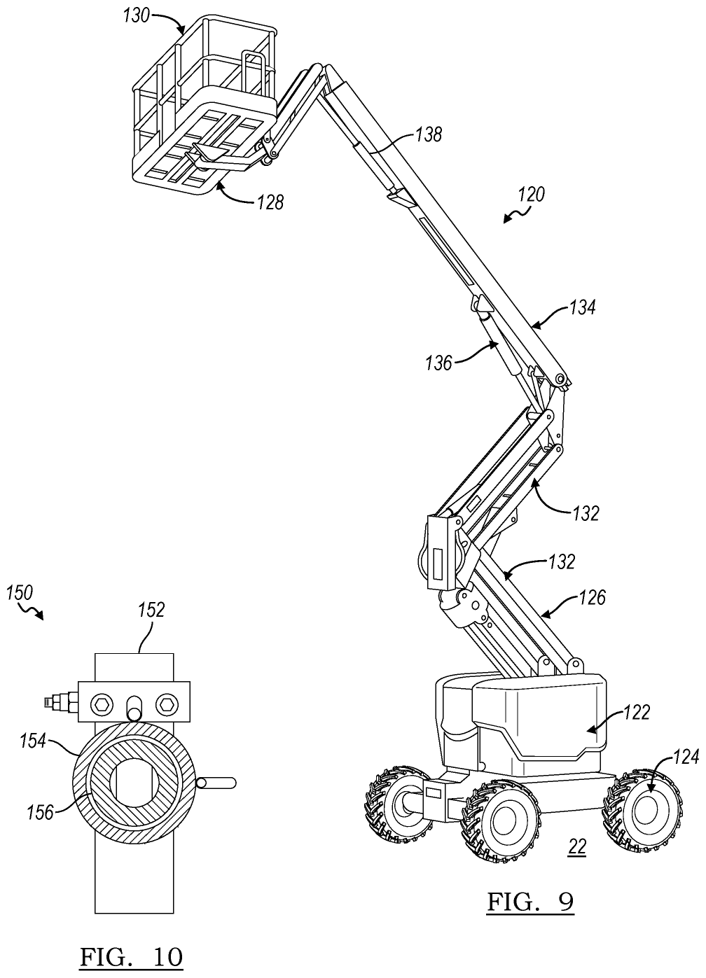

FIG. 9 illustrates an aerial lift assembly 120 according to another embodiment. The aerial lift assembly 120 includes a chassis 122 to support the aerial lift assembly 120 upon the ground 22. The chassis 122 is supported upon a plurality of wheels 124 that contact the ground 22 for support and mobility of the aerial lift assembly 120. A linkage assembly 126 is connected to the chassis 122 to extend and retract from the chassis 122. A platform 128 is provided on the linkage assembly 126 with a perimeter railing 130. The linkage assembly 126 includes a plurality of four bar linkages 132 with an extendable boom 134. Actuator assemblies 136 are provided to pivot the four bar linkages and the extendable boom 134. An actuator assembly 138 is provided to extend the boom 134. The load sensing pin 68 can be installed in any of the pivotal connections in the linkage assembly 126 or the actuator assemblies 136, 138 to measure applicable loading.

FIG. 10 illustrates a cylinder rod assembly 150 for an actuator assembly 36, 66, 136, 138 of one of the prior embodiments. The cylinder rod assembly 150 includes a clevis mount 152 for pivotal connection with a linkage assembly. A barrel 154 is mounted to the clevis mount 152. A rod 156 is received in the barrel 154 for translation relative to the barrel 154. A load sensor can be installed upon the rod 156 and used in combination with an angle sensor to determine applicable loads and vectors. The load sensor detects in-line forces, which improves accuracy and reliability over hydraulic pressure detection.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An aerial lift assembly comprising:
a chassis;
a linkage assembly with a plurality of pivotally connected links, the linkage assembly connected to the chassis to extend and retract from the chassis;
a platform supported upon the linkage assembly to extend and retract from the chassis; and
a load sensor provided upon a pivotal connection of one of the plurality of links of the linkage assembly.

2. The aerial lift assembly of claim 1 wherein the load sensor is further defined as only one load sensor.

3. The aerial lift assembly of claim 1 further comprising an actuator connected to the linkage assembly to extend and retract the linkage assembly.

4. The aerial lift assembly of claim 3 wherein the load sensor is provided upon the connection of the actuator and the linkage assembly.

5. The aerial lift assembly of claim 4 further comprising a pin as the pivotal connection of the actuator and the linkage assembly.

6. The aerial lift assembly of claim 4 wherein the load sensor is provided to detect an applicable load and load vector.

7. The aerial lift assembly of claim 1 further comprising a controller in communication with the load sensor to receive an applicable load measurement and a load vector for each of a plurality of positions.

8. The aerial lift assembly of claim 7 wherein the controller is programmed to calculate a platform height in response to receipt of the applicable load measurements and the load vectors for the plurality of positions.

9. The aerial lift assembly of claim 7 wherein the controller is programmed to calculate a platform load in response to receipt of the applicable load measurements and the load vectors for the plurality of positions.

10. The aerial lift assembly of claim 1 wherein the linkage assembly further comprises a series of pivotally connected stack links that are retractable to collapse and stack upon the chassis.

11. The aerial lift assembly of claim 10 further comprising an actuator connected to the linkage assembly to extend and retract the linkage assembly.

12. The aerial lift assembly of claim 11 wherein the load sensor is provided upon the connection of the actuator and the linkage assembly.

13. An aerial lift assembly comprising:
a chassis;
a linkage assembly is connected to the chassis to extend and retract from the chassis;
a platform supported upon the linkage assembly to extend and retract from the chassis;
an actuator connected to the linkage assembly to extend and retract the linkage assembly; and
a load sensor provided upon the connection of the actuator and the linkage assembly.

14. The aerial lift assembly of claim 13 further comprising a pin as the pivotal connection of the actuator and the linkage assembly.

15. The aerial lift assembly of claim 13 wherein the load sensor is provided to detect an applicable load and load vector.

16. The aerial lift assembly of claim 13 further comprising a controller in communication with the load sensor to receive an applicable load measurement and a load vector for each of a plurality of positions.

17. The aerial lift assembly of claim 16 wherein the controller is programmed to calculate a platform height in response to receipt of the applicable load measurements and the load vectors for the plurality of positions.

18. The aerial lift assembly of claim 16 wherein the controller is programmed to calculate a platform load in response to receipt of the applicable load measurements and the load vectors for the plurality of positions.

19. An aerial lift assembly comprising:
a chassis;
a linkage assembly with a plurality of pivotally connected links, the linkage assembly connected to the chassis to extend and retract from the chassis;
a platform supported upon the linkage assembly to extend and retract from the chassis;
an actuator connected to the linkage assembly to extend and retract the linkage assembly;
a pin as the pivotal connection of the actuator and the linkage assembly;
a load sensor provided upon the pin of the actuator and one of the plurality of links of the linkage assembly to detect an applicable load and load vector; and
a controller in communication with the load sensor to receive an applicable load measurement and a load vector for each of a plurality of positions, wherein the controller is programmed to:
calculate a platform height in response to receipt of the applicable load measurements and the load vectors for the plurality of positions, and
calculate a platform load in response to receipt of the applicable load measurements and the load vectors for the plurality of positions.

20. The aerial lift assembly of claim 19 wherein the linkage assembly further comprises a series of pivotally connected stack links that are retractable to collapse and stack upon the chassis.
